(19) United States
(12) Patent Application Publication
(10) Pub. No.: US 2015/0223169 A1
(43) Pub. Date: Aug. 6, 2015

(54) METHOD, APPARATUS, AND COMPUTER PROGRAM PRODUCT FOR INITIAL INDICATION OF BLOCK ALLOCATION WITHIN PAGE FOR WIRELESS NETWORKS

(71) Applicant: Nokia Corporation, Espoo (FI)

(72) Inventor: Chittabrata Ghosh, Fremont, CA (US)

(21) Appl. No.: 14/174,402

(22) Filed: Feb. 6, 2014

(51) Int. Cl. H04W 52/02; H04W 68/02; H04W 72/00

(52) U.S. Cl. CPC H04W 52/0216; H04W 72/005; H04W 68/02

(57) ABSTRACT

Method, apparatus, and computer program product embodiments improve power saving in network environments. An example method embodiment comprises: generating by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and periodically broadcasting, by the access node, the plurality of page slice elements in a beacon frame to a plurality of associated wireless client devices.

### FIELD

The field of technology relates to wireless communication and more particularly to traffic indication map encoding and compression for power save in network environments.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for power saving in network environments.

An example embodiment of the invention includes a method comprising:

associating, by a wireless device, to an access node;

receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;

determining the page slice element corresponding to a page index associated to the wireless device;

if the indication of the corresponding page slice element indicates that the page slice element is for the currently served page index, determining whether the access node has data for the wireless device; and

if the indication of the corresponding page slice element indicates that the page slice element is not for the currently served page index, using a time value in the management frame to determine when the access node will transmit a management frame wherein the corresponding page index is served.

An example embodiment of the invention includes a method comprising:

wherein the management frame is a beacon and wherein the page slice element structure depends on the indication.

An example embodiment of the invention includes a method comprising:

wherein a page slice count field in the page slice element indicates at least one short management frame within a management frame interval following the management frame;

receiving, by the wireless device, the at least one short management frame within the management frame interval following the management frame, the short management frame including an additional page slice element; and

determining from the additional page slice element whether the access node has data for the wireless device.

An example embodiment of the invention includes a method comprising:

wherein the page slice element includes a reserved value of 0 for a page slice length field and for a page slice count field, to support wireless devices in an entire page within one management frame interval.

An example embodiment of the invention includes a method comprising:

generating, by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and

periodically broadcasting, by the access node, the plurality of page slice elements in a beacon frame to a plurality of associated wireless client devices.

An example embodiment of the invention includes a method comprising:

wherein the management frame is a beacon and wherein the page slice element structure depends on the indication.

An example embodiment of the invention includes a method comprising:

wherein a page slice count field in the page slice element indicates at least one short management frame within a management frame interval following the management frame;

generating, by the access node, the at least one short management frame within the management frame interval following the management frame, the short management frame including an additional page slice element; and

periodically broadcasting, by the access node, the additional page slice element in the at least one short management frame to the plurality of associated wireless client devices.

An example embodiment of the invention includes a method comprising:

wherein the page slice element includes a reserved value of 0 for a page slice length field and for a page slice count field, to support wireless devices in an entire page within one management frame interval.

An example embodiment of the invention includes an apparatus comprising:

at least one processor;

at least one memory including computer program code;

the at least one memory and the computer program code configured to, with the at least one processor, cause the apparatus at least to:

associate to an access node;

receive a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;

determine the page slice element corresponding to a page index associated to the apparatus;

if the indication of the corresponding page slice element indicates that the page slice element is for the currently served page index, determine whether the access node has data for the apparatus; and

if the indication of the corresponding page slice element indicates that the page slice element is not for the currently served page index, use a time value in the management frame to determine when the access node will transmit a management frame wherein the corresponding page index is served.

An example embodiment of the invention includes an apparatus comprising:

wherein the management frame is a beacon and wherein the page slice element structure depends on the indication.

An example embodiment of the invention includes an apparatus comprising:

wherein a page slice count field in the page slice element indicates at least one short management frame within a management frame interval following the management frame;

the at least one memory and the computer program code configured to, with the at least one processor, cause the apparatus at least to:

receive the at least one short management frame within the management frame interval following the management frame, the short management frame including an additional page slice element; and

determine from the additional page slice element whether the access node has data for the apparatus.

An example embodiment of the invention includes an apparatus comprising:

wherein the page slice element includes a reserved value of 0 for a page slice length field and for a page slice count field, to support wireless devices in an entire page within one management frame interval.

An example embodiment of the invention includes an apparatus comprising:

at least one processor;

at least one memory including computer program code;

the at least one memory and the computer program code configured to, with the at least one processor, cause the apparatus at least to:

generate a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and

periodically broadcast the plurality of page slice elements in a beacon frame to a plurality of associated wireless client devices.

An example embodiment of the invention includes an apparatus comprising:

wherein the management frame is a beacon and wherein the page slice element structure depends on the indication.

An example embodiment of the invention includes an apparatus comprising:

wherein a page slice count field in the page slice element indicates at least one short management frame within a management frame interval following the management frame;

the at least one memory and the computer program code configured to, with the at least one processor, cause the apparatus at least to:

generate the at least one short management frame within the management frame interval following the management frame, the short management frame including an additional page slice element; and

periodically broadcast the additional page slice element in the at least one short management frame to the plurality of associated wireless client devices.

An example embodiment of the invention includes an apparatus comprising:

wherein the page slice element includes a reserved value of 0 for a page slice length field and for a page slice count field, to support wireless devices in an entire page within one management frame interval.

An example embodiment of the invention includes a computer program product comprising computer executable program code recorded on a computer readable, non-transitory storage medium, the computer executable program code comprising:

code for associating, by a wireless device, to an access node;

code for receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;

code for determining the page slice element corresponding to a page index associated to the wireless device;

code for if the indication of the corresponding page slice element indicates that the page slice element is for the currently served page index, determining whether the access node has data for the wireless device; and

code for if the indication of the corresponding page slice element indicates that the page slice element is not for the currently served page index, using a time value in the management frame to determine when the access node will transmit a management frame wherein the corresponding page index is served.

An example embodiment of the invention includes a computer program product comprising computer executable program code recorded on a computer readable, non-transitory storage medium, the computer executable program code comprising:

code for generating, by an access node a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and

code for periodically broadcasting, by the access node, the plurality of page slice elements in a beacon frame to a plurality of associated wireless client devices.

The resulting embodiments provide improved power saving in network environments.

### DESCRIPTION OF THE FIGURES

FIG. 1 shows the example network diagram, wherein a wireless access point (AP) device broadcasts a delivery traffic indication map (DTIM) beacon frame followed by three traffic indication map (TIM) short beacons, to a plurality of wireless client devices (STAs), according to an example embodiment of the invention.

FIG. 1A shows an example timing diagram of the DTIM beacon and the following three TIM short beacons, each including a respective page slice information element, according to an example embodiment of the invention.

FIG. 1B shows an example frame structure of the DTIM beacon frame that includes a page slice information element, according to an example embodiment of the invention.

FIG. 1C shows an example frame structure of the page slice information element, for the entire page in one DTIM beacon, according to an example embodiment of the invention.

FIG. 1D shows an example timing diagram of buffered data indication for newly associated STAs, according to an example embodiment of the invention.

FIG. 1E shows an example frame structure of the page slice information element, for the entire page in one DTIM beacon, according to an example embodiment of the invention.

FIG. 1F shows an example timing diagram of STAs in an entire page served within one DTIM beacon with no further TIM beacons, according to an example embodiment of the invention.

FIG. 1G shows an example three level hierarchy of a traffic indication map (TIM) as a page, block, and sub-block structure, according to an example embodiment of the invention.

FIG. 2A is an example functional block diagram, illustrating an example wireless client device, according to an example embodiment of the invention.

FIG. 2B is an example flow diagram of operational steps in the wireless client device of FIG. 2A, according to an example embodiment of the invention.

FIG. 3A is an example functional block diagram, illustrating an example wireless access point device, according to an example embodiment of the invention.

FIG. 3B is an example flow diagram of operational steps in the wireless access point device of FIG. 3A, according to an example embodiment of the invention.

FIG. 4 illustrates an example embodiment of the invention, wherein examples of removable storage media are shown, in accordance with at least one embodiment of the present invention.

### DISCUSSION OF EXAMPLE EMBODIMENTS OF THE INVENTION

This section is organized into the following topics:

A. WLAN Communication Technology

B. Initial Indication of Block Allocation Within Page for Wireless Networks

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007 (incorporated herein by reference). Since then, emerging broadband applications have stimulated interest in developing very high-speed wireless networks for short range communication, for example, the IEEE 802.11n, the planned IEEE 802.11ac, and the planned IEEE 802.11ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detecteIMd, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the mobile device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TGTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the mobile device. There may be no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

A Traffic Indication Map (TIM) is a field transmitted in beacon frames, used to inform associated wireless client devices that the access point has buffered data waiting to be transmitted to them. Access points buffer frames of data for wireless client devices while they are sleeping in a low-power state. The access point transmits beacons at a regular interval, the target beacon transmission time (TBTT). The Traffic Indication Map (TIM) information element in the periodically transmitted beacon frame, indicates which wireless client devices have buffered data waiting to be accessed in the access point. Each frame of buffered data is identified by an association identifier (AID) associated with a specific wireless client device. The AID is used to logically identify the wireless client device to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless client devices must wake up and listen for the periodic beacon frames to receive the Traffic Indication Map (TIM). By examining the TIM, a wireless client device may determine if the access point has buffered data waiting for it. To retrieve the buffered data, the wireless client device may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

A delivery traffic indication message (DTIM) interval is the interval between the consecutive TBTTs of beacons containing a DTIM. The value, expressed in time units, is equal to the product of the value in the Beacon Interval field and the value in the DTIM Period subfield in the TIM element in Beacon frames.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

According to plans, the IEEE 802.11ah WLAN standard under development will operate below 1 GHz, has a greater range and lower obstruction losses due to its longer wavelength. IEEE 802.11ah will provide wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

B. Initial Indication of Block Allocation within Page for Wireless Networks

In sensor networks and smart grid applications, large numbers of wireless client devices, both fixed and mobile, will need to communicate with an access point device. In the case of IEEE 802.11ah networks, it is envisioned to have a Wi-Fi network of 6000 wireless client devices (STAs) being served by an access point (AP). The client devices may operate on battery power and must conserve their power during long periods of inactivity punctuated by short durations of communication sessions. The client devices will need to awaken periodically to receive the traffic indication map (TIM) in a beacon, to determine if the access point has buffered data for them. A conventional TIM bitmap with 251 octets has the capacity to inform approximately 2007 STAs. Almost three times this number of octets may be necessary in order to support 6000 STAs. However, such an increase in the number of octets may result in a very large TIM bitmap size.

Page slicing has been proposed in the context of IEEE 802.11ah because it may not be possible to serve all STAs in a page within a beacon interval. Hence, instead of indicating buffered data for all STAs within a page, the AP may indicate buffered data indication for a subset of STAs within a page, termed as a page slice. A page slice may consist of a subset of blocks instead of having all 32 blocks for AIDs of STAs. The indication of buffered data for such page slices is done using a Page Slice information element. The length of the page slice (blocks of AIDs) is indicated by the Page Slice Length field and the number of such slices within a DTIM beacon interval is indicated in the Page Slice Count field. Each page is indicated by the Page Index field.

A proposal has been made that relates to IEEE 802.11ah, in general to networks having large number of associated stations. In a proposal, the stations in the network are divided into different pages, i.e. groups which are served one group at a time period. The groups that are served may be indicated in DTIM (long) beacons.

Certain structured identifiers are used for the stations, i.e. each page group comprises blocks and sub-blocks and the station identifiers indicate to which page, block, and sub-block it belongs.

When a station associates to the access point, it does not know when the next DTIM beacon for the page will be received. Therefore, the newly associated STA needs to listen to every DTIM beacon to see whether it is indicating for the corresponding group within the page it (the STA) belongs to. Single DTIM period may serve only a subset of STAs in the page, and thus multiple DTIM periods may be dedicated to each page. Therefore, the newly associated STA may need to listen to quite a large number of DTIM beacons before it receives a relevant one. Since 11ah network is meant for power saving STAs, this is considered a first problem.

In accordance with an example embodiment of the invention, the DTIM beacon comprises a Page Slice Element (PSE) for every page. The PSE may comprise a field indicating the type of the PSE, to accommodate different types of PSEs:

If the PSE is for a page index that is not served in this beacon period, the PSE indicates the number of DTIM beacons with respect to the current DTIM beacon before the next DTIM period that serves the page index. The time value is stated in the page slice element corresponding to the page index associated to the wireless device. This helps the STAs to sleep until there is buffered information in the AP for them. This time value is in terms of the number of DTIM beacons, i.e., number of management frame transmissions. However, in other example embodiments, the time value may be expressed as units of time.

If the PSE is for a page index that is served in this beacon period, the PSE may have more information on page slicing.

In accordance with an example embodiment of the invention, the DTIM beacon informs the STAs when there would be a next DTIM beacon for non-paged STAs. In am embodiment, the DTIM beacon may be replaced by a management frame.

In accordance with an example embodiment of the invention, a STA associates to an access node. The STA receives a management frame, such as a beacon frame or a DTIM beacon frame, indicating a plurality of page slice elements. The length of the page slice element or the page slice element structure depends on the indication. Each page slice element comprises a page index associated to a subset of STAs within a wireless network. Each page slice element comprises an indication whether the corresponding page index is served after the management frame and before the next DTIM beacon frame. The plurality of page slice elements are for different page indices. The STA determines the page slice element corresponding to the page index associated to the STA. If the indication of the corresponding page slice element indicates that the page slice element is for the currently served page index, the STA determines whether the access node has data for the STA. If the indication of the corresponding page slice element indicates that the page slice element is not for the currently served page index, the STA uses a time value in the management frame to determine when the access node will transmit a next management frame wherein the corresponding page index is served.

The DTIM beacon comprises page slice element which tells to how many TIM intervals are assigned within the DTIM beacon. The DTIM beacon serves the first page slice, and there are so called short (TIM) beacons that serve the remaining slices within the indicated page (if there are more than one slice). Each page slice consists of a subset of blocks, each block constituting 8 sub-blocks. Each sub-block can address up to 8 STA identifiers. In other words, a page slice within a DTIM or a TIM Beacon may serve multiple STAs, with a maximum of 512 STAs, over a full page of 32 blocks.

The DTIM beacon comprises of a Page Slice information element with the Page Slice Count (number of slices within page) and the Page Slice Length (number of served blocks within a page slice) fields. Both are five bits long. It has been proposed that the 0 values for these fields would be reserved. Since Page Slice Length has 5 bits, the maximum number of served blocks would then be 31 (starting from 1 instead of 0) instead of the maximum 32. This is a second identified problem. If the zero bits are reserved, there would be no way how to serve STAs in the 32nd block within single page.

In accordance with an embodiment of the invention, the AP utilizes the reserved value of 0 for Page Slice Length and Page Slice Count field, to solve the second problem of supporting STAs in the entire page within one beacon interval. A value of 0 in Page Slice Length will indicate the entire 32 blocks of a page and a value of 0 in Page Slice Count will indicate just one (short) beacon. In such a case, to reduce the signaling overhead, the AP shall not transmit the fields namely, Page Offset and TIM Offset fields. This Page Slice element may have the Page Slice Indication bits set to 01. In accordance with other embodiments of the invention, the page slice indication may comprise more than two bits, to support a larger number of pages.

The Page Bitmap field indicates the buffered data presence (bit set to 1) for any of the STA AIDs in the block corresponding to the bit location in the field. For example, an octet in the Page Bitmap with value 00000001 indicates that there is buffered data for any of the STA AIDs only in the 7th block.

A STA that has newly associated, receives the first DTIM beacon and decodes the page Slice Indication and Page Period fields indicated in the Page Slice element. Based on the value (in number of DTIM beacons), the STA wakes up again to receive another Page Slice element with the Page Slice indication bits set to 10. The STA identifies the TIM (short) beacon within a DTIM beacon interval to wake up in order to receive the buffered data and also send uplink data.

In case the STA receives a Page Slice element with page Slice Indication bits set to 01, it stays awake to receive buffered data within the same DTIM beacon. In accordance with other embodiments of the invention, the page slice indication may comprise more than two bits, to support a larger number of pages.

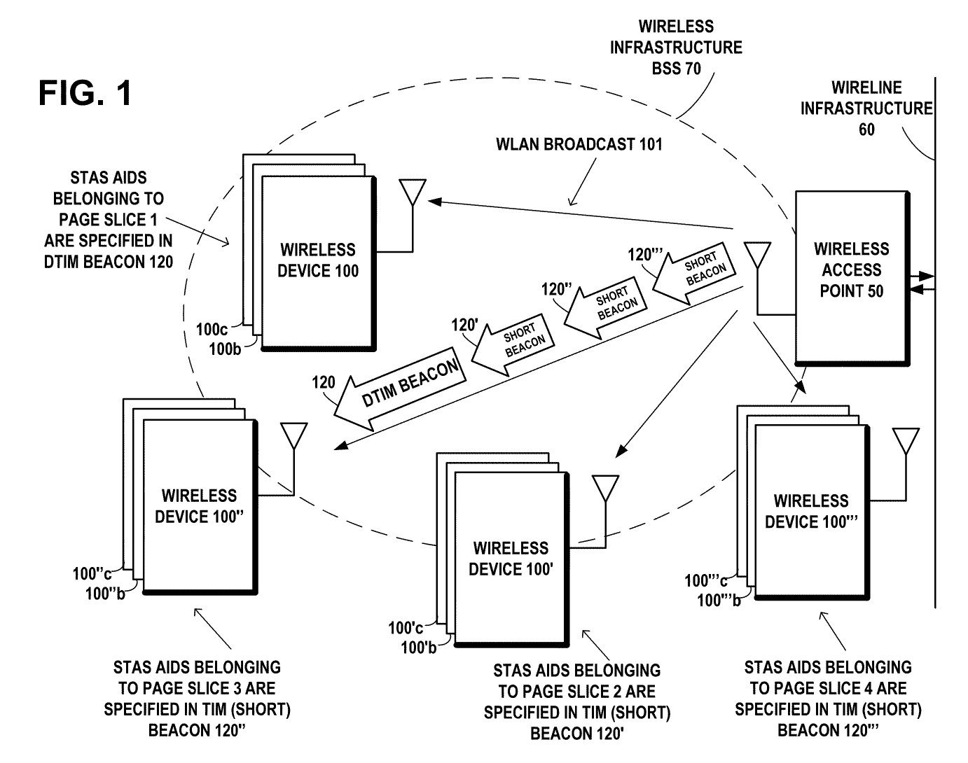

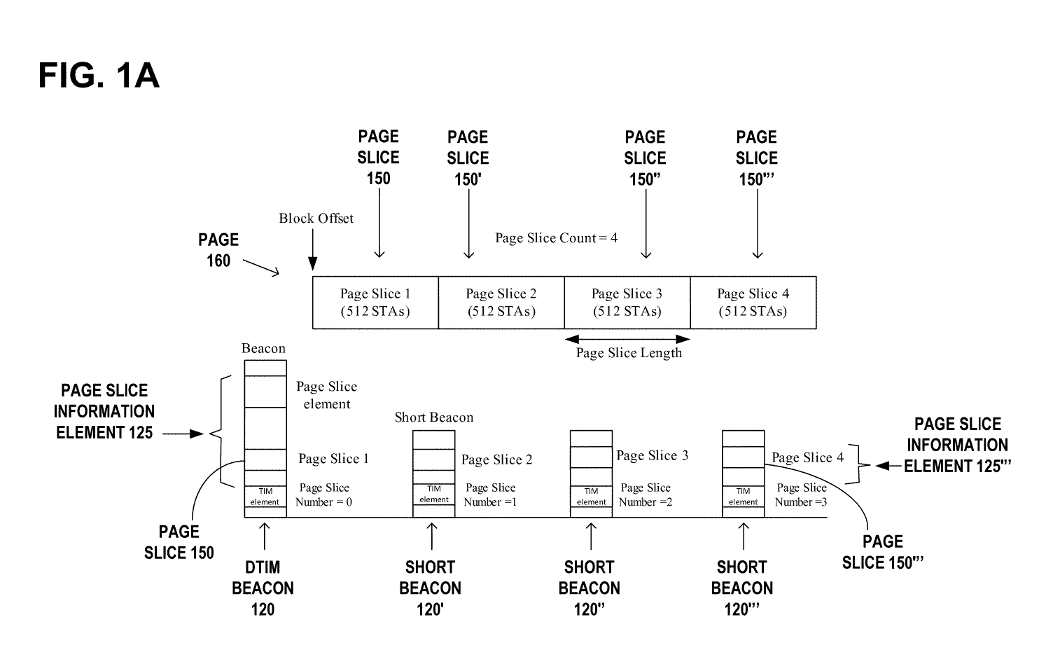

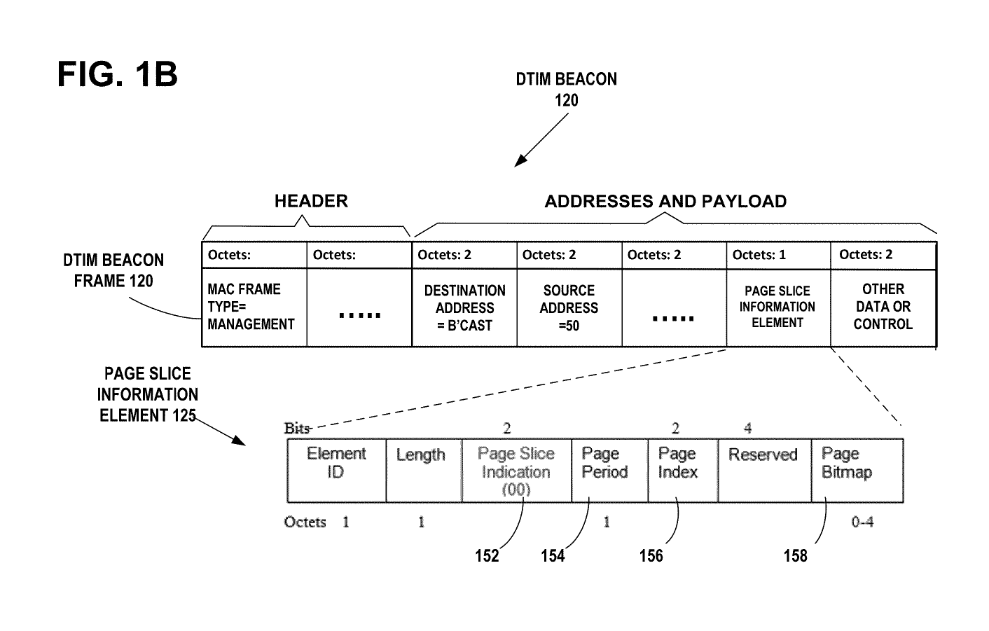

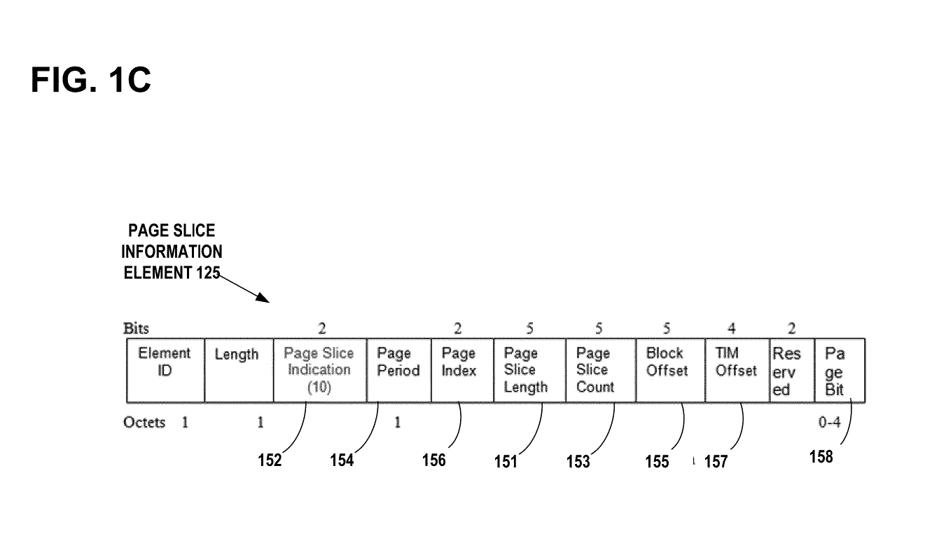

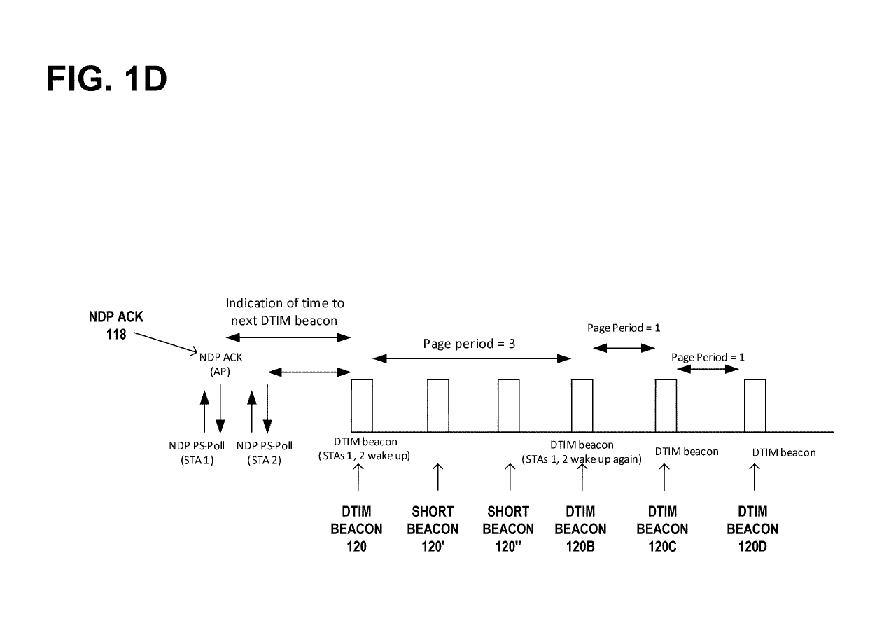

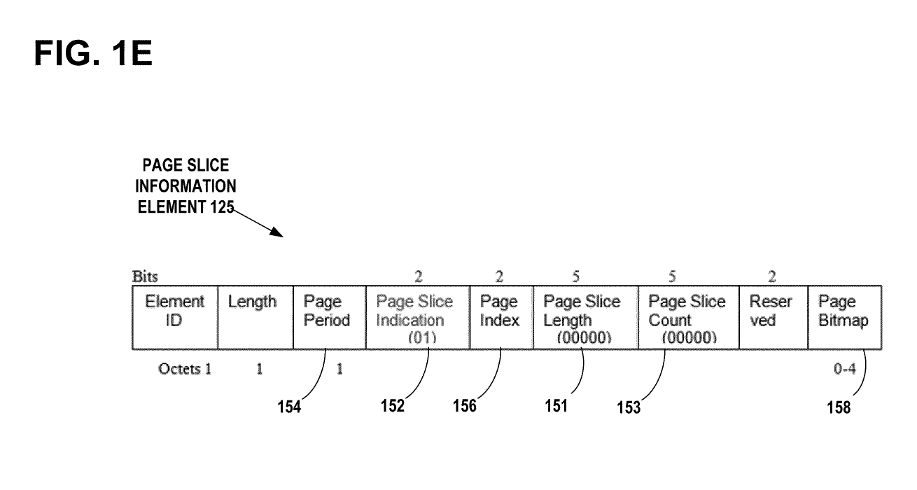

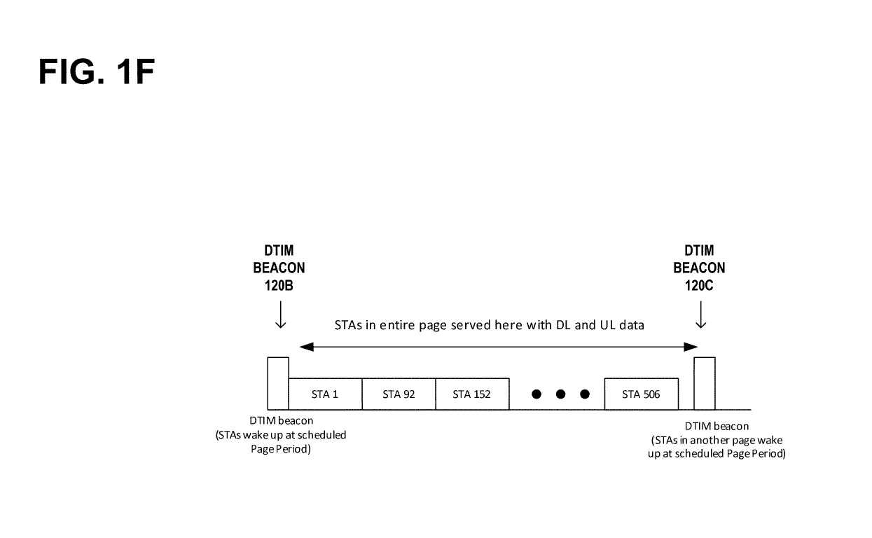

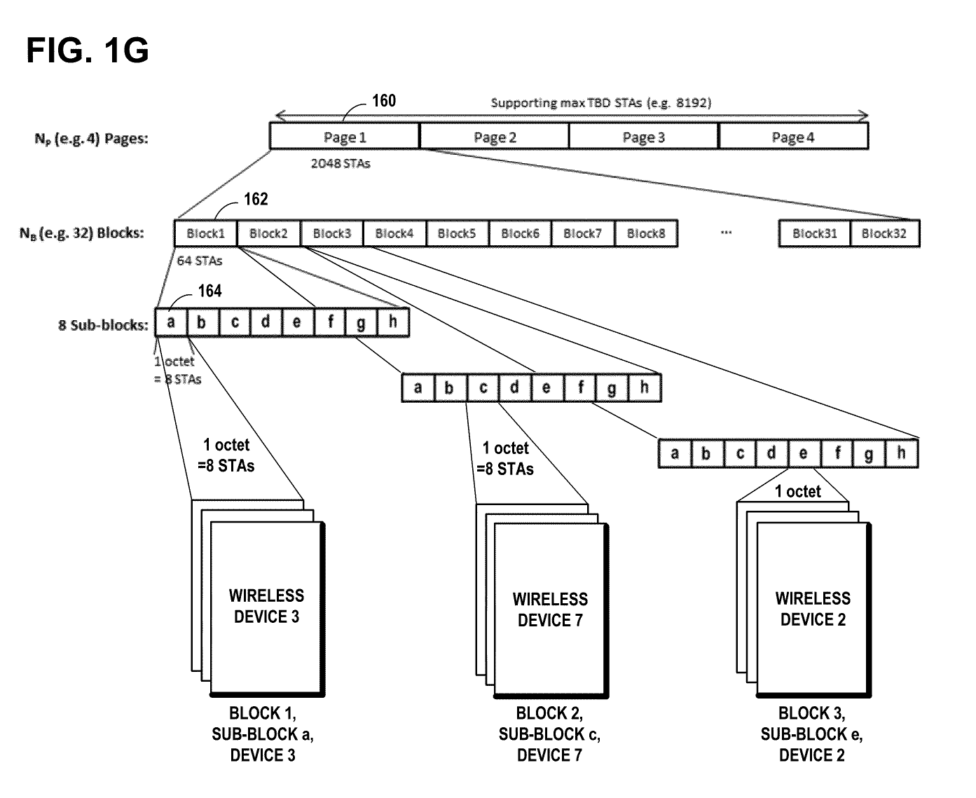

FIG. 1 shows the example network diagram, wherein a wireless access point (AP) device 50 manages a wireless infrastructure BSS 70, transmits in a WLAN broadcast 101, a delivery traffic indication map (DTIM) beacon frame 120 followed by three traffic indication map (TIM) short beacons 120′, 120″, and 120′″, to a plurality of wireless client devices (STAs) 100, 100′, 100″, and 100″. In example embodiments of the invention, an access node may be an access point for a wireless local area network, or a base station for another kind of wireless network. The plurality of wireless client devices are logically grouped into STAs whose association identifiers (AIDs) belong to a page 160 (shown in FIG. 1A) representing 2048 STAs. A page 160 is divided into four page slices 150, 150′, 150″, and 150′ (shown in FIG. 1A), each slice consisting of 512 AIDs from 512 STAs, indicating buffered data that may be available in the AP 50 for all STAs within the page slice. The first page slice 150 is specified in a page slice information element 125 (shown in FIG. 1B), in the first beacon, the DTIM beacon 120, to a first group of 512 STAs whose AIDs belong to the first page slice. The second page slice 150′ is specified in a second page slice information element in the second beacon, which is the first TIM short beacon 120′, to a second group of 512 STAs whose AIDs belong to the second page slice. The third page slice 150″ is specified in a third page slice information element in the third beacon, which is the second TIM short beacon 120″, to a third group of 512 STAs whose AIDs belong to the third page slice. The fourth page slice 150′ is specified in a page slice information element in the fourth beacon, which is the third TIM short beacon 120′″, to a fourth group of 512 STAs whose AIDs belong to the fourth page slice. In other words, four page slices are served within a DTIM beacon interval with three TIM beacon intervals, according to an example embodiment of the invention. The wireless client device 100 may be a sensor device or a node in a smart grid. Both the wireless client device 100 and the access point device 50 may be devices operating according to the future IEEE 802.11ah communications protocol. The access point device 50 may be connected to a wireline infrastructure 60.

FIG. 1A shows an example timing diagram of the DTIM beacon 120 and the following three TIM short beacons 120′, 120″, and 120′″, each including a respective page slice information element 125 to 125′. The plurality of wireless client devices are logically grouped into STAs whose association identifiers (AIDs) belong to page 160 representing 2048 STAs. The page 160 is divided into four page slices 150, 150′, 150″, and 150′″, each slice consisting of 512 AIDs from 512 STAs, indicating buffered data that may be available in the AP 50 for all STAs within the page slice, according to an example embodiment of the invention.

FIG. 1B shows an example frame structure of the DTIM beacon frame 120 that includes a page slice information element 125, according to an example embodiment of the invention. The AP 50 indicates page slice information for STAs that have newly associated within the DTIM beacon interval right after their association. The STAs obtain the information of the time to the next scheduled DTIM beacon by sending an NDP PS-Poll and receiving an NDP ACK (shown in FIG. 1D) from the AP 50 with that information. Within the Page Slice element 125 in DTIM beacon 120, the AP sets the value of the Page Index 156 corresponding to the index of the page 160 to which these newly associated STAs belong. The Page Period field 154 (in terms of the number of DTIM beacons) in the Page Slice element 125, is set to a value to indicate the next DTIM beacon when the AP intends to inform the STAs of the existence of buffered data, by means of the corresponding page slices. The current Page Slice element 125 indicates buffered data for blocks corresponding to the bit position in the Page Bitmap field 158, to indicate any STA within that block bit set to 1 shall wake up to retrieve the data. Two of the Reserved bits are used for the page slice indication field 152. The bits 00 in page slice indication field 152, indicate that this is an initial Page Slice element for newly associated STAs, according to an example embodiment of the invention. In accordance with other embodiments of the invention, the page slice indication may comprise more than two bits, to support a larger number of pages. The Page Slice Length 151 and page Slice Count 153 fields (shown in FIG. 1C) are not included in the Page Slice element 125 for the newly associated STAs, according to an example embodiment of the invention.

FIG. 1C shows an example frame structure of the page slice information element 125, for the entire page in one DTIM beacon 120. At the indicated Page Period 154 (e.g., at DTIM beacon with Page Period=3), the AP schedules a Page Slice element in the DTIM beacon for the (then newly associated) STA AIDs with values defined in the fields of the Page Slice element. This Page Slice element will have the Page Slice Indication 152 bits set to 10, according to an example embodiment of the invention. In accordance with other embodiments of the invention, the page slice indication may comprise more than two bits, to support a larger number of pages.

FIG. 1D shows an example timing diagram of buffered data indication for newly associated STAs. The AP indicates page slice information for STAs that have newly associated, with in the DTIM beacon right after their association. The STAs obtain the information of the time to the next scheduled DTIM beacon by sending an NDP PS-Poll and receiving an NDP ACK 118 from the AP with that information, according to an example embodiment of the invention. The NDP ACK frame 118 sent by the AP to the newly associated wireless device, states the interval to wait until the next DTIM beacon 120 that states the page index for the page containing the AID associated with the wireless device. However, the AP may now indicate a different value in the Page Period (e.g., Page Period=1 in the Figure), which corresponds to the actual periodicity for this group of STAs when the buffered data will be indicated for them.

FIG. 1E shows an example frame structure of the page slice information element 125, for the entire page in one DTIM beacon 120. The AP utilizes the reserved value of 0 for Page Slice Length 151 and Page Slice Count 153 field. A value of 0 in Page Slice Length will indicate the entire 32 blocks of a page and a value of 0 in Page Slice Count will indicate just one (short) beacon. In such a case, to reduce the signaling overhead, the AP shall not transmit the fields namely, Page Offset 155 and TIM Offset fields 157 (shown in FIG. 1C). This Page Slice element will have the Page Slice Indication 152 bits set to 01. The Page Bitmap field 158 indicates the buffered data presence (bit set to 1) for any of the STA AIDs in the block corresponding to the bit location in the field. For example, an octet in the Page Bitmap 158 with value 00000001 indicates that there is buffered data for any of the STA AIDs only in the 7^{th} block, according to an example embodiment of the invention.

FIG. 1F shows an example timing diagram of STAs in an entire page served within one DTIM beacon 120 with no further TIM short beacons. A STA that has newly associated receives the first DTIM beacon 120 and decodes the page Slice Indication 152 and Page Period 154 fields indicated in the Page Slice element 125. Based on the value (in number of DTIM beacons), the STA wakes up again to receive another Page Slice element with the Page Slice indication bits 152 set to 10. The STA identifies the TIM (short) beacon within a DTIM beacon interval to wake up in order to receive the buffered data and also send uplink data. In case the STA receives a Page Slice element 125 with page Slice Indication 152 bits set to 01, it stays awake to receive buffered data within the same DTIM beacon 120, according to an example embodiment of the invention.

FIG. 1G shows an example of a three level hierarchy of the traffic indication map (TIM) bitmap 158 in accordance with an embodiment of the invention, in terms of a page 160, block 162, and sub-block 164, wherein the total association identifier (AID) space for a page 160 is divided into a hierarchical arrangement of 32 blocks 162, identified in the FIG. 1G as Block1, Block2, . . . Block32, each containing 64 wireless client devices (STAs). The blocks 162 are further divided into one or more sub-blocks 164, with each sub-block including eight wireless client devices. The one or more block bitmap fields 156 represents the one or more sub-blocks.

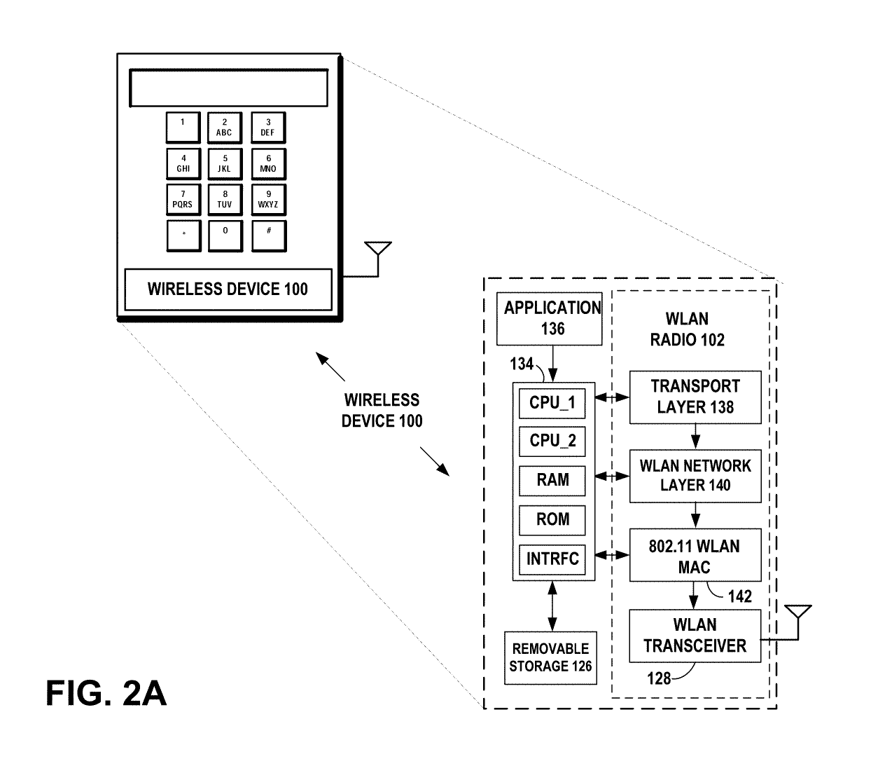

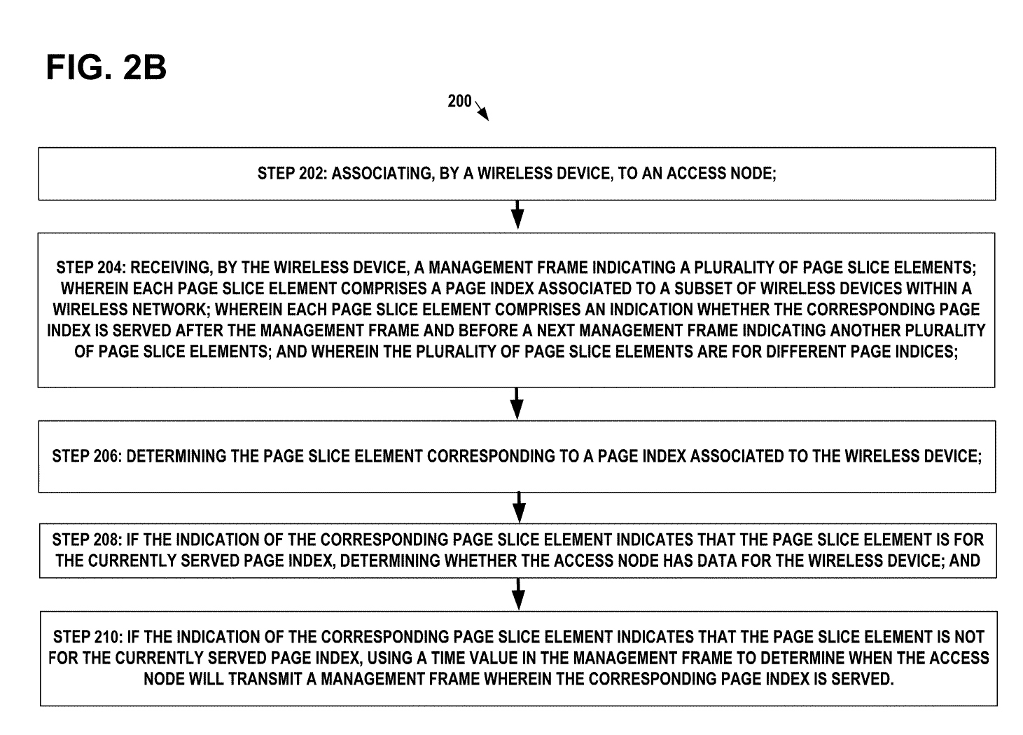

FIG. 2A is an example functional block diagram, illustrating an example wireless client device 100, according to an example embodiment of the invention. The example wireless client device 100 may include a processor 134 that may include a dual or multi-core central processing unit CPU_1 and CPU_2, a RAM memory, a ROM memory, and an interface for a keypad, display, and other input/output devices. The example wireless client device 100 may include a protocol stack, including the transceiver 128 and IEEE 802.11 MAC 142, which may be based, for example, on an IEEE 802.11 WLAN standard. The protocol stack may also include a network layer 140, a transport layer 138, and an application program 136.

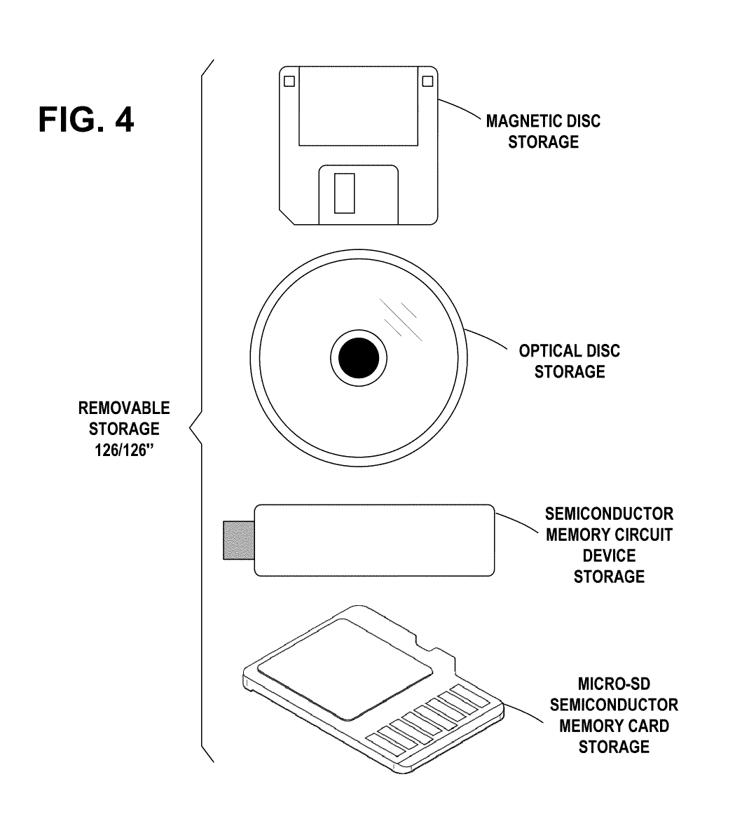

In an example embodiment, the interface circuits in FIG. 2A may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 4, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the wireless client device (STA) 100 of FIG. 2A, comprises:

at least one processor 134;

at least one memory, RAM, ROM, and/or removable storage 126 including computer program code represented by the flow diagram of FIG. 2B;

the at least one memory and the computer program code configured to, with the at least one processor, cause the wireless client device (STA) 100 at least to perform the following.

The STA associates to an access node.

The STA receives a management frame, such as a beacon frame or a DTIM beacon frame, indicating a plurality of page slice elements. The page slice element structure depends on the indication. Each page slice element comprises a page index associated to a subset of STAs within a wireless network. Each page slice element comprises an indication whether the corresponding page index is served after the management frame and before the next DTIM beacon frame. The plurality of page slice elements are for different page indices.

The STA determines the page slice element corresponding to the page index associated to the STA.

If the indication of the corresponding page slice element indicates that the page slice element is for the currently served page index, the STA determines whether the access node has data for the STA.

If the indication of the corresponding page slice element indicates that the page slice element is not for the currently served page index, the STA uses a time value in the management frame to determine when the access node will transmit a next management frame wherein the corresponding page index is served.

FIG. 2B is an example flow diagram 200 of operational steps in the wireless client device 100 of FIG. 2A, wherein the wireless client device 100 receives from the wireless access point device 50, a DTIM beacon frame 120 from the wireless access point device, including page slice information element 125, according to an example embodiment of the invention.

The steps of the flow diagram 200 of FIG. 2B may represent computer code instructions stored in the RAM and/or ROM memory of the wireless client device 100, which when executed by the central processing units (CPU), carry out the functions of an example embodiment of the invention. The steps may be carried out in another order than shown and individual steps may be combined or separated into component steps.

Step 202: associating, by a wireless device, to an access node;

Step 204: receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;

Step 206: determining the page slice element corresponding to a page index associated to the wireless device;

Step 208: if the indication of the corresponding page slice element indicates that the page slice element is for the currently served page index, determining whether the access node has data for the wireless device; and

Step 210: if the indication of the corresponding page slice element indicates that the page slice element is not for the currently served page index, using a time value in the management frame to determine when the access node will transmit a management frame wherein the corresponding page index is served.

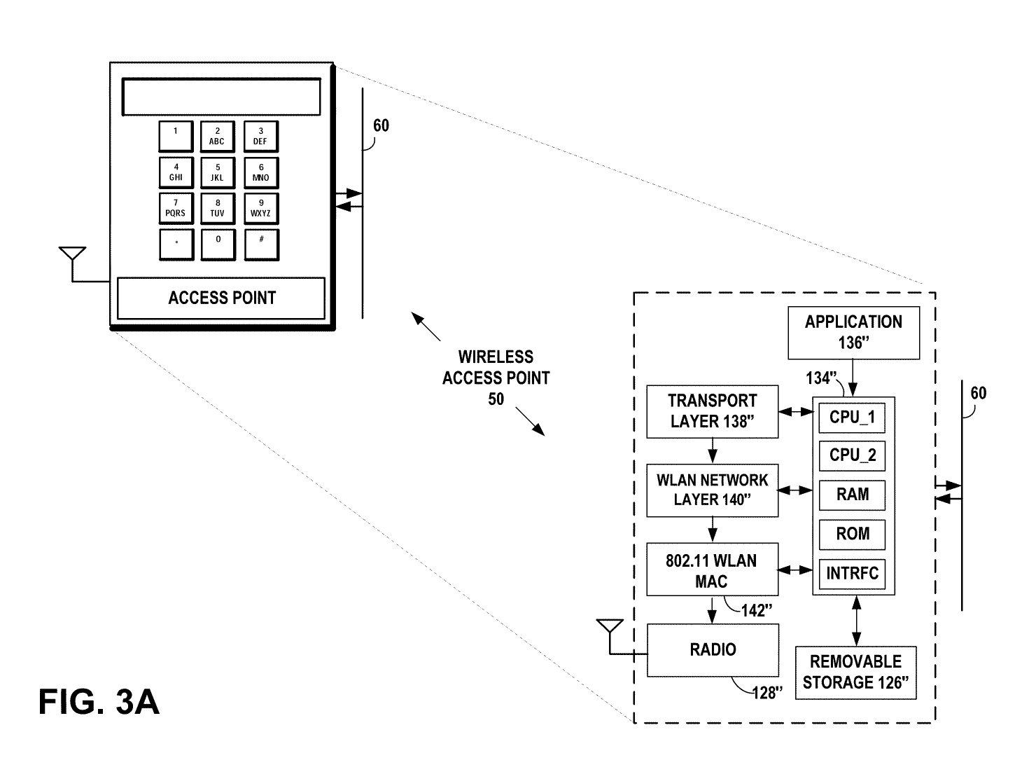

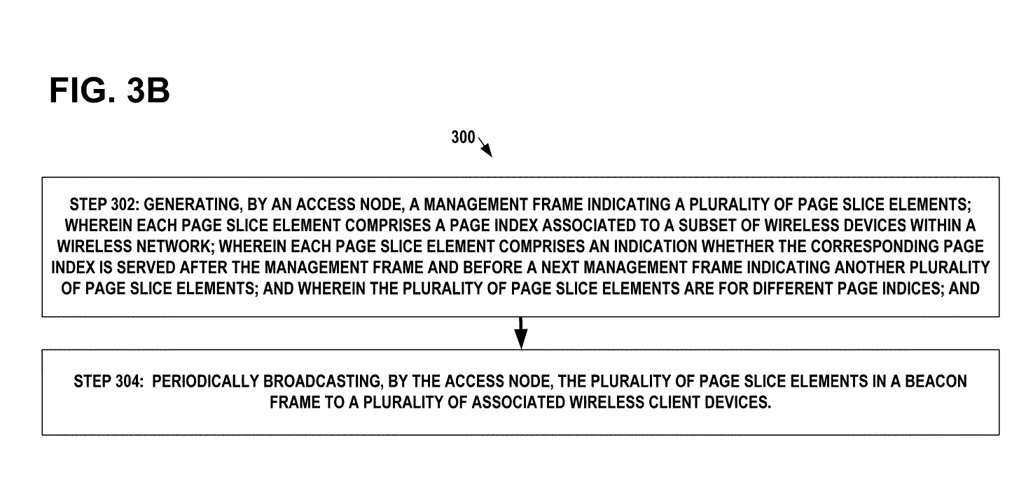

FIG. 3A is an example functional block diagram, illustrating an example wireless access point device 50, according to an example embodiment of the invention. The example wireless access point device 50 may include a processor 134″ that may include a dual or multi-core central processing unit CPU_1 and CPU_2, a RAM memory, a ROM memory, and an interface for a keypad, display, and other input/output devices. The example wireless access point device 50 may include a protocol stack, including the transceiver 128″ and IEEE 802.11 MAC 142″. The protocol stack may also include a network layer 140″, a transport layer 138″, and an application program 136″.

In an example embodiment, the interface circuits in FIG. 3A may interface with one or more radio transceivers, battery and other power sources, key pad, touch screen, display, microphone, speakers, ear pieces, camera or other imaging devices, etc. The RAM and ROM may be removable memory devices 126″ such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126″, as shown in FIG. 4, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the wireless access point device 50 of FIG. 3A, comprises:

at least one processor 134″;

at least one memory, RAM, ROM, and/or removable storage 126″ including computer program code represented by the flow diagram of FIG. 3B;

the at least one memory and the computer program code configured to, with the at least one processor, cause the wireless access point device 50 at least to: perform the following.

The AP 50 generates a management frame 120, such as a beacon frame or a DTIM beacon frame, indicating a plurality of page slice elements 125. The page slice element structure depends on the indication. Each page slice element comprises a page index associated to a subset of STAs within a wireless network. Each page slice element comprises an indication whether the corresponding page index is served after the management frame and before the next DTIM beacon frame. The plurality of page slice elements are for different page indices.

periodically broadcasting the plurality of page slice elements 125 in a beacon frame 120 to a plurality of associated wireless client devices 100.

FIG. 3B is an example flow diagram 300 of operational steps in the wireless access point device 50 of FIG. 3A, wherein the wireless access point device generates a plurality of page slice elements 125 and broadcasts the plurality of page slice elements 125 in a beacon frame 120 to the wireless client devices, according to an example embodiment of the invention.

The steps of the flow diagram 300 of FIG. 3B may represent computer code instructions stored in the RAM and/or ROM memory, which when executed by the central processing units (CPU), carry out the functions of an example embodiment of the invention. The steps may be carried out in another order than shown and individual steps may be combined or separated into component steps.

Step 302: generating, by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and

Step 304: periodically broadcasting, by the access node, the plurality of page slice elements in a beacon frame to a plurality of associated wireless client devices.

In example embodiments of the invention, an access node may be an access point for a wireless local area network, or a base station for another kind of wireless network.

FIG. 4 illustrates an example embodiment of the invention, wherein examples of removable storage media 126 and 126″ are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, wireless networks having a need for example embodiments of the invention, may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks, as well as short range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short Range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the wireless client device 100 may be, for example, a miniature device such as a key fob, smart card, jewelry, or the like. The wireless client device 100 may be, for example, a larger device such as a cell phone, smart phone, flip-phone, PDA, graphic pad, or even larger devices such as a laptop computer, an automobile, and the like.

In an example embodiment of the invention, an apparatus comprises:

means for associating, by a wireless device, to an access node;

means for receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;

means for determining the page slice element corresponding to a page index associated to the wireless device;

means for if the indication of the corresponding page slice element indicates that the page slice element is for the currently served page index, determining whether the access node has data for the wireless device; and

means for if the indication of the corresponding page slice element indicates that the page slice element is not for the currently served page index, using a time value in the management frame to determine when the access node will transmit a management frame wherein the corresponding page index is served.

In an example embodiment of the invention, an apparatus comprises:

means for generating, by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and

means for periodically broadcasting, by the access node, the plurality of page slice elements in a beacon frame to a plurality of associated wireless client devices.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
associating, by a wireless device, to an access node;
receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;
determining the page slice element corresponding to a page index associated to the wireless device;
if the indication of the corresponding page slice element indicates that the page slice element is for the currently served page index, determining whether the access node has data for the wireless device; and
if the indication of the corresponding page slice element indicates that the page slice element is not for the currently served page index, using a time value in the management frame to determine when the access node will transmit a management frame wherein the corresponding page index is served.

2. The method of claim 1, wherein the management frame is a beacon and wherein the page slice element structure depends on the indication.

3. The method of claim 1, further comprising:
wherein a page slice count field in the page slice element indicates at least one short management frame within a management frame interval following the management frame;
receiving, by the wireless device, the at least one short management frame within the management frame interval following the management frame, the short management frame including an additional page slice element; and
determining from the additional page slice element whether the access node has data for the wireless device.

4. The method of claim 1, wherein the page slice element includes a reserved value of 0 for a page slice length field and for a page slice count field, to support wireless devices in an entire page within one management frame interval.

5. A method, comprising:
generating, by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and
periodically broadcasting, by the access node, the plurality of page slice elements in a beacon frame to a plurality of associated wireless client devices.

6. The method of claim 5, wherein the management frame is a beacon and wherein the page slice element structure depends on the indication.

7. The method of claim 5, further comprising:
wherein a page slice count field in the page slice element indicates at least one short management frame within a management frame interval following the management frame;
generating, by the access node, the at least one short management frame within the management frame interval following the management frame, the short management frame including an additional page slice element; and
periodically broadcasting, by the access node, the additional page slice element in the at least one short management frame to the plurality of associated wireless client devices.

8. The method of claim 5, wherein the page slice element includes a reserved value of 0 for a page slice length field and for a page slice count field, to support wireless devices in an entire page within one management frame interval.

9. An apparatus, comprising:
at least one processor;
at least one memory including computer program code;
the at least one memory and the computer program code configured to, with the at least one processor, cause the apparatus at least to:
associate to an access node;
receive a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;
determine the page slice element corresponding to a page index associated to the apparatus;
if the indication of the corresponding page slice element indicates that the page slice element is for the currently served page index, determine whether the access node has data for the apparatus; and
if the indication of the corresponding page slice element indicates that the page slice element is not for the currently served page index, use a time value in the management frame to determine when the access node will transmit a management frame wherein the corresponding page index is served.

10. The apparatus of claim 9, wherein the management frame is a beacon and wherein the page slice element structure depends on the indication.

11. The apparatus of claim 9, further comprising:
wherein a page slice count field in the page slice element indicates at least one short management frame within a management frame interval following the management frame;
the at least one memory and the computer program code configured to, with the at least one processor, cause the apparatus at least to:
receive the at least one short management frame within the management frame interval following the management frame, the short management frame including an additional page slice element; and
determine from the additional page slice element whether the access node has data for the apparatus.

12. The apparatus of claim 9, wherein the page slice element includes a reserved value of 0 for a page slice length field and for a page slice count field, to support wireless devices in an entire page within one management frame interval.

13. An apparatus, comprising:
at least one processor;
at least one memory including computer program code;
the at least one memory and the computer program code configured to, with the at least one processor, cause the apparatus at least to:
generate a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and
periodically broadcast the plurality of page slice elements in a beacon frame to a plurality of associated wireless client devices.

14. The apparatus of claim 13, wherein the management frame is a beacon and wherein the page slice element structure depends on the indication.

15. The apparatus of claim 13, further comprising:
wherein a page slice count field in the page slice element indicates at least one short management frame within a management frame interval following the management frame;
the at least one memory and the computer program code configured to, with the at least one processor, cause the apparatus at least to:
generate the at least one short management frame within the management frame interval following the management frame, the short management frame including an additional page slice element; and
periodically broadcast the additional page slice element in the at least one short management frame to the plurality of associated wireless client devices.

16. The apparatus of claim 13, wherein the page slice element includes a reserved value of 0 for a page slice length field and for a page slice count field, to support wireless devices in an entire page within one management frame interval.

17. A computer program product comprising computer executable program code recorded on a computer readable, non-transitory storage medium, the computer executable program code comprising:
code for associating, by a wireless device, to an access node;
code for receiving, by the wireless device, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices;
code for determining the page slice element corresponding to a page index associated to the wireless device;
code for if the indication of the corresponding page slice element indicates that the page slice element is for the currently served page index, determining whether the access node has data for the wireless device; and
code for if the indication of the corresponding page slice element indicates that the page slice element is not for the currently served page index, using a time value in the management frame to determine when the access node will transmit a management frame wherein the corresponding page index is served.

18. A computer program product comprising computer executable program code recorded on a computer readable, non-transitory storage medium, the computer executable program code comprising:
code for generating, by an access node, a management frame indicating a plurality of page slice elements; wherein each page slice element comprises a page index associated to a subset of wireless devices within a wireless network; wherein each page slice element comprises an indication whether a corresponding page index is served after the management frame and before a next management frame indicating another plurality of page slice elements; and wherein the plurality of page slice elements are for different page indices; and
code for periodically broadcasting, by the access node, the plurality of page slice elements in a beacon frame to a plurality of associated wireless client devices.
